(19) United States
(12) Patent Application Publication
(10) Pub. No.: US 2008/0257441 A1
(43) Pub. Date: Oct. 23, 2008

(54) Co-extruded plastic tubing

(76) Inventors: Brock Allen, Orange, MA (US); Richard Brooks, Templeton, MA (US)

Correspondence Address: JACOBSON HOLMAN PLLC, 400 SEVENTH STREET N.W., SUITE 600, WASHINGTON, DC, 20004, US

(21) Appl. No.: 11/785,316

(22) Filed: Apr. 17, 2007

(51) Int. Cl. F16L 11/20

(52) U.S. Cl. 138/137

(57) ABSTRACT

Two-layer tubing for housing an insert, comprising an extremely lubricious tubular inner layer and a tubular outer layer disposed radially outward of and surrounding the inner layer, wherein the co-efficient of friction of the inner layer is less than the co-efficient of friction of the outer layer. The outer layer consists essentially of a thermoplastic elastomer, preferably a polyolefin-based material, with a specific gravity averaging between about 0.91 and 0.97 g/cm³ and an MFI of 0.20-2.00 g/10 min. The inner layer consists essentially of an organosilicon compound with the empirical formula R2SiO, where R is an organic group. The inner layer is a copolymer consisting essentially of a polyethylene based material with a silicone-based additive to decrease the coefficient of friction to a point below that of the outer layer. The total material volume ratio of the outside layer to the inner layer is approximately 4:1.

### BACKGROUND OF THE INVENTION

1. Field of the Invention

The present invention relates to protective tubing for industrial applications, for example medical tubing. More specifically, the invention relates to medical tubing for cardiovascular guidewire dispenser coils and the like.

2. Related Art

Cardiovascular guidewire dispenser tubing coils are used to house the stainless steel or nitinol guide wires used to carry a stent or balloon during angioplasty or vascular procedures. The actual guidewire is inserted into the patient's vascular system and is manipulated by the surgeon to the blockage area where it can deliver a stent or balloon as conditions warrant.

Conventional tubing for guidewire dispenser tubing coils and for housing stainless steel or nitinol guidewires used in angioplasty, stent, and other vascular procedures is made of single layer high density polyethylene or polypropylene.

U.S. Published Appl. No. 2005/0124976 discloses either a co-extruded or tri-extruded tube; however it serves as the actual catheter, delivering the balloon or stent to the sight during an angioplasty or cardiovascular medical procedure. U.S. Pat. No. 6,431,219 refers to co-extruded or tri-extruded PVC medical tubing, with each layer comprised of a different grade of PVC made with a different plasticizer.

It is to the solution of these and other problems that the present invention is directed.

### SUMMARY OF THE INVENTION

It is accordingly a primary object of the present invention to provide medical grade tubing having an extremely lubricious inner layer enabling a guidewire or another steel wire to move more easily through it, reducing the co-efficient of friction.

It is another object of the present invention to provide protective tubing for industrial applications that require an extremely lubricious inner path to facilitate the smooth and rapid movement of a steel wire or rigid composite rod or spring, used as a moving component of a machine, device, or piece of equipment.

These and other objects of the invention are achieved by the provision of two-layer tubing for housing an insert, comprising an extremely lubricious tubular inner layer and a tubular outer layer disposed radially outward of and surrounding the inner layer, wherein the co-efficient of friction of the inner layer is less than the co-efficient of friction of the outer layer. The outer layer consists essentially of a thermoplastic elastomer, preferably a polyolefin-based material, with a specific gravity averaging between about 0.91 g/cm³ and about 0.97 g/cm³ and an MFI of 0.20-2.00 g/10 min, as defined by ASTM D-1238; and the inner layer consists essentially of an organosilicon compound with the empirical formula R₂SiO, where R is an organic group. The polyolefin-based material can be, for example, a polyethylene-based material or a polypropylene-based material.

In one aspect of the invention, the inner layer is a copolymer consisting essentially of a polyethylene based material with a silicone-based additive to decrease the coefficient of friction to a point below that of the outer layer.

In another aspect of the invention, the total material volume ratio of the outside layer to the inner layer is approximately 4:1.

In still another aspect of the invention, in which the tubing is used to house guidewire for medical applications, the outer layer consists essentially of medical-grade high-density polyethylene and the inner layer consists essentially of a medical grade silicone co-polymer.

Other objects, features and advantages of the present invention will be apparent to those skilled in the art upon a reading of this specification including the accompanying drawings.

### BRIEF DESCRIPTION OF THE DRAWINGS

The invention is better understood by reading the following Detailed Description of the Preferred Embodiments with reference to the accompanying drawing figures, in which like reference numerals refer to like elements throughout, and in which:

FIG. 1 is a perspective view showing the two-layer tubing in accordance with the present invention.

FIG. 2 is a perspective view showing the tubing of FIG. 1 in use in a guidewire dispenser tubing coil.

FIG. 3 is an enlarged view of section 3 of FIG. 2.

### DETAILED DESCRIPTION OF THE PREFERRED EMBODIMENTS

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

The following definitions are used herein:

Low density—soft to the touch, having a specific gravity averaging between about 0.91 g/cm³ and about 0.94 g/cm³.

High density—stiff to the touch, having a specific gravity averaging between about 0.94 g/cm³ and about 0.97 g/cm³.

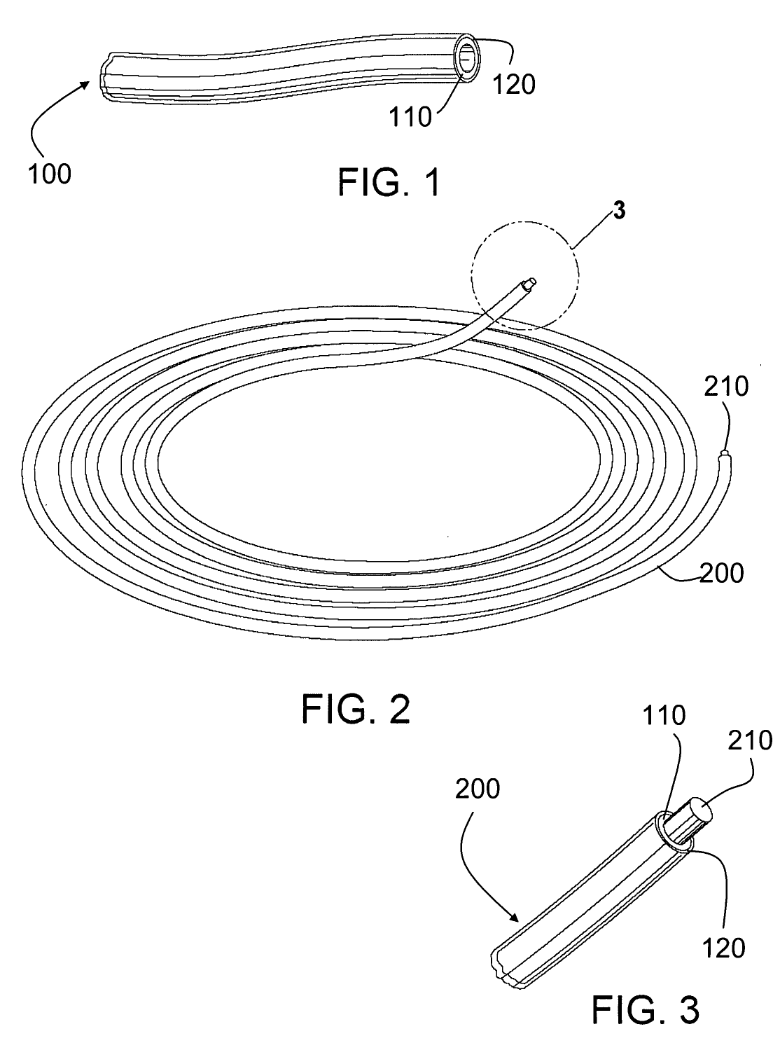

Referring now to FIG. 1, there is shown two-layer extruded tubing 100 in accordance with the present invention. The tubing 100 comprises an extremely lubricious tubular inner layer 110 and a tubular outer layer 120 disposed radially outward of and surrounding the inner layer 110, where the co-efficient of friction of the inner layer is less than the co-efficient of friction of the outer layer. The outer layer 120 consists essentially of a thermoplastic elastomer, preferably a polyolefin-based material, with a specific gravity averaging between about 0.91 g/cm³ and about 0.97 g/cm³ and an MFI of 0.20-2.00 g/10 min, as defined by ASTM D-1238. The inner layer 110 consists essentially of an organosilicon compound with the empirical formula R₂SiO, where R is an organic group. The polyolefin-based material can be, for example, a polyethylene-based material or a polypropylene-based material. Preferably, the inner layer 110 is a copolymer consisting essentially of a polyethylene based material with a silicone-based additive to decrease the coefficient of friction to a point below that of the outer layer 120. The total material volume ratio of the outside layer to the inner layer is approximately 4:1.

It is envisioned that the primary use for the tubing 100 is as guidewire dispenser tubing, such as for housing stainless steel or nitinol guidewires 200 used in angioplasty, stent, and other vascular procedures. The tubing 100 is shown in FIG. 2 in a dispenser coil 200 with the guidewire 210 inserted therein. However, the tubing 100 can be used for housing other inserts, for example, steel wire or rigid composite rod or spring, used as a moving component of a machine, device, or piece of equipment.

The inner layer 110 allows inserting the guidewire 210 faster and more efficiently both during the assembly/manufacturing process in which the guidewire 210 is inserted into the dispenser tubing 200, and during the actual vascular procedures, during which the surgeon must withdraw the guidewire 210 from the dispenser tubing 200. The more lubricious the inner layer 110 of the tubing 100, the smoother and faster the guidewire 210 can move through it. The inner layer 110 performs the same function where the tubing is used as a housing or dispenser for inserts other than guidewire for vascular procedures.

The tubing 100 is manufactured using a plastic co-extrusion process in which the raw materials of the inner and outer layers 110 and 120 are fed in extruders with a screw L/D ratio ranging from about 18:1 to about 30:1. The raw materials are melted with a machine barrel temperature of about 350° F. to about 450° F. The melted materials are co-extruded using a co-extruder and then introduced into the male and female parts of a die or tooling set.

There are two flow channels that encompass the inner layer material. The first flow channel is a flow channel from the co-extruder to the die, and the second flow channel is a flow channel built into the die to feed the inner layer material to the male and female tips of the die, which determine the finished size of the tubing 100. The outer layer material is fed from the co-extruder directly into the die.

The first flow channel encompasses the inner layer material until it enters the second flow channel in the die, which has an area that is less than 0.75 square inches and is equal to or less than the first flow channel connecting the die to the co-extruder. The inner and outer layer materials flow through the die until they converge, causing the materials to thermally bond and create single walled, dual layer co-extruded tubing 100. The tubing 100 is then cooled, for example using water, and controlled, for example using vacuum, circulated water, air pressure, and takeoff speed and extruder output. The combination of these control methods allows certain dimensional values to be held in the process. Examples of different dimensions that can be achieved are given in the following Table:

TABLE

| Outer Diameter | Inner Diameter |
|---|---|
| .152″ | .100″ |
| .225″ | .175″ |
| .225″ | .185″ |
| .235 | .185″ |
| .235 | .195″ |
| .375 | .250 |

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

What is claimed is:

1. Two-layer tubing for housing an insert, comprising an extremely lubricious tubular inner layer and a tubular outer layer disposed radially outward of and surrounding the inner layer, wherein:
the co-efficient of friction of the inner layer is less than the co-efficient of friction of the outer layer;
the outer layer consists essentially of a thermoplastic elastomer; and
the inner layer consists essentially of an organosilicon compound.

2. The tubing of claim 1, wherein the thermoplastic elastomer is a polyolefin-based material.

3. The tubing of claim 1, wherein the thermoplastic elastomer has a specific gravity averaging between about 0.91 g/cm3 and about 0.97 g/cm3 and an MFI of 0.20-2.00 g/10 min, as defined by ASTM D-1238; and
wherein the organosilicon compound has the empirical formula R₂SiO, where R is an organic group.

4. The tubing of claim 1, wherein the inner layer is a copolymer consisting essentially of a polyethylene-based material with a silicone-based additive to decrease the coefficient of friction to a point below that of the outer layer.

5. The tubing of claim 2, wherein the polyolefin-based material is a polyethylene-based material.

6. The tubing of claim 2, wherein the polyolefin-based material is a polypropylene-based material.

7. The tubing of claim 1, wherein the total material volume ratio of the outside layer to the inner layer is approximately 4:1.

8. The tubing of claim 1, wherein the outer layer consists essentially of medical-grade high-density polyethylene and the inner layer consists essentially of a medical grade silicone co-polymer.

9. A dispenser assembly comprising the tubing of claim 1 and an insert housed inside the inner layer.

10. The dispenser assembly of claim 8, wherein the outer layer consists essentially of medical-grade high-density polyethylene, the inner layer consists essentially of a medical grade silicone co-polymer, and the insert comprises a guidewire suitable for use in vascular procedures.

11. The dispenser assembly of claim 8, wherein the insert comprises a moving component of a machine.

12. Two-layer tubing for housing an insert, comprising an extremely lubricious tubular inner layer and a tubular outer layer disposed radially outward of and surrounding the inner layer, the total material volume ratio of the outside layer to the inner layer being approximately 4:1, wherein:
the co-efficient of friction of the inner layer is less than the co-efficient of friction of the outer layer;
the outer layer consists essentially of a thermoplastic elastomer having a specific gravity averaging between about 0.91 g/cm3 and about 0.97 g/cm3 and an MFI of 0.20-2.00 g/10 min, as defined by ASTM D-1238;
the inner layer consists essentially of an organosilicon compound and an additive to decrease the coefficient of friction to a point below that of the outer layer, the organosilicon compound having the empirical formula R₂SiO, where R is an organic group.

13. The tubing of claim 12, wherein the thermoplastic elastomer is a polyolefin-based material.

14. Two-layer tubing for housing an insert, comprising an extremely lubricious tubular inner layer and a tubular outer layer disposed radially outward of and surrounding the inner layer, wherein:
the co-efficient of friction of the inner layer is less than the co-efficient of friction of the outer layer;
the outer layer consists essentially of medical-grade high-density polyethylene; and
the inner layer consists essentially of a medical grade silicone co-polymer and an additive to decrease the coefficient of friction to a point below that of the outer layer.
